(19) United States
(12) Patent Application Publication
(10) Pub. No.: US 2026/0167556 A1
(43) Pub. Date: Jun. 18, 2026

(54) GLASS WOOL FIBER-STRETCHING BURNER

(71) Applicant: SAINT-GOBAIN ISOVER, COURBEVOIE (FR)

(72) Inventors: Antoine VERDIER, COURBEVOIE (FR); Guillaume CLEON, COURBEVOIE (FR); Vincent BONHOMME, COURBEVOIE (FR)

(21) Appl. No.: 18/852,008

(22) PCT Filed: Mar. 24, 2023
(86) PCT No.: PCT/EP2023/057730

§ 371 Date: Sep. 27, 2024

(30) Foreign Application Priority Data
Mar. 30, 2022 (WO) PCT/FR2022/050601

(51) Int. Cl. C03B 37/15; C03B 37/07

(52) U.S. Cl. CPC C03B 37/15; C03B 37/07

(57) ABSTRACT

A burner suitable for stretching glass fibers, includes a ring-shaped combustion chamber opening onto a circular expansion slot, the direction of which is substantially parallel to the axis of the burner, and an injection system including at least one injector arranged to supply the combustion chamber with fuel and with oxidizer in the gaseous state, wherein the injector includes at least one angular deflection element suitable for generating a stream of oxidizer and/or fuel, the flow of which forms a swirl.

The invention relates to a burner for use in a glass fiber forming method, during which fiber stretching is achieved by high-temperature, high-velocity gas streams emitted by said burners alone, or in combination with other means such as centrifuging means or die-type stretching means.

The fiber-stretching method commonly used to produce glass fiber is the method known as internal centrifugation. It consists in introducing a net of the stretchable material in the molten state into a centrifuge, also called a fiberizing spinner, rotating at high speed. Such a fiberizing spinner may alternatively be equipped with a bottom and is pierced at its periphery by a very large number of orifices through which the material is sprayed in the form of filaments under the effect of centrifugal force. By means of a burner of annular shape, these filaments are then subjected to the action of a gaseous annular stretching current with a high temperature and speed (with the temperature potentially reaching 1000° C., and the speed 250 m/s, depending on the desired product) running along the wall of the centrifuge which thins them and transforms them into fibers. For further details on fiber-stretching methods using the internal centrifugation method, reference may be made to patent applications WO99/65835 and WO97/15532.

Such a method of fiber-stretching the glass wool is to be distinguished from that commonly used for rock fiber, referred to as an external centrifugation fiber-stretching method. For this method, the material to be fiber-stretched is poured in the molten state onto the peripheral treads of centrifuge wheels that are rotating, is accelerated by these wheels, becomes detached therefrom, and is partially transformed into fibers under the effect of centrifugal force, a gas stream being emitted tangentially to the peripheral treads of the wheels so as to pick up the fiber-streched material by separating it from the non-fiber-stretched material and conveying it to a receiving member. Reference may be made, for example, to fiber-stretching by external centrifugation, in patent application EP195725.

For glass wool fiber-stretching, patent EP0189354B1 discloses a burner for stretching glass fibers, comprising a ring-shaped combustion chamber delimited by walls made of refractory material, opening out onto a circular expansion slot, the direction of which is substantially parallel to the axis of the burner.

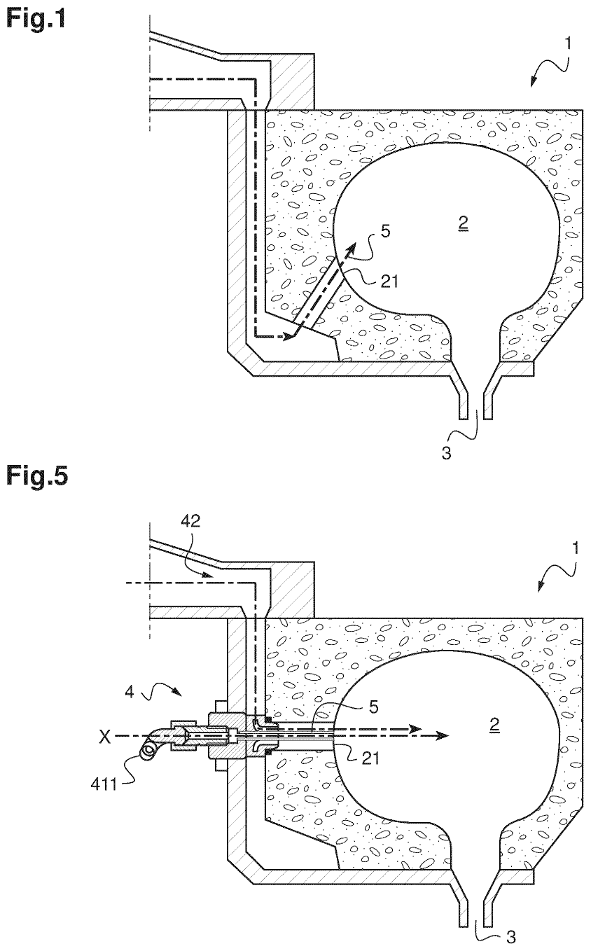

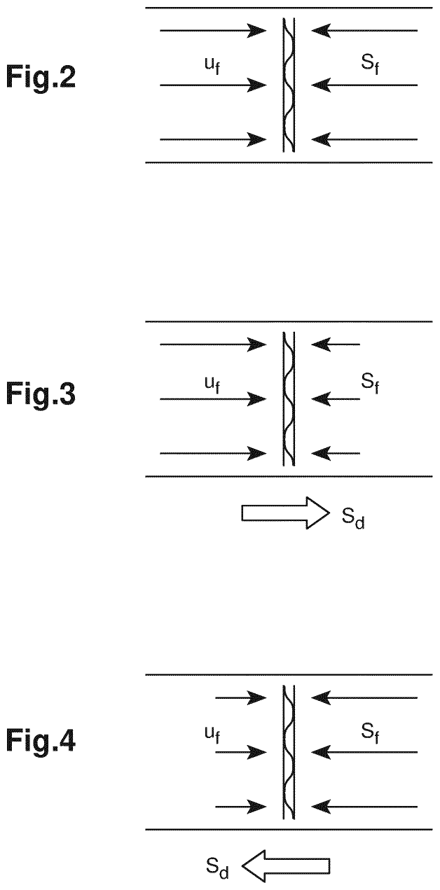

It should be noted that burners of the type disclosed in EP0189354B1, also shown in [FIG. 1], comprise an injector opening out at the bottom-peripheral part of the combustion chamber, in order to inject a mixture of oxidizer and fuel gas. In the context of these burners, fuel and oxidizer are therefore mixed before being introduced into the combustion chamber. This technological choice originates in the physical mechanisms involved in stabilizing burner flames. As shown in FIGS. 2, 3 and 4, flame stability depends mainly on two opposing velocities: the ejection velocity of the fuel/oxidizer mixture flow (uf), on the one hand, and the flame displacement velocity (Sf), on the other hand. If these two velocities are balanced, as shown in [FIG. 2], the flame is stabilized. In such a state, the flame can alternatively remain “hooked” to the injector, or be kept at a constant distance from it. Conversely, if the flame velocity (Sf) is greater than the velocity of the fuel/oxidizer mixture (uf), as shown in [FIG. 3], the flame moves (Sd) toward the injector source, with the risk of explosion, or at least injector damage, inherent in such a situation. This is known as “flashback”. In contrast, if the flame velocity (Sf) is lower than the velocity of the fuel/oxidizer mixture (uf), as shown in [FIG. 4], the flame will move away (Sd) from the injector and risk being extinguished or, in other words, “blown out”.

In this context, it has been observed that when the effective ratio of the quantity of fuel to the quantity of oxidizer decreases, by reducing the fuel concentration, the laminar combustion velocity at the flame periphery also decreases. As a result, the likelihood of combustion instabilities, and therefore flame instability, is greater. In other words, the flame is more sensitive to fluctuations in the so-called “lean” combustion regime, where the ratio of the quantity of fuel to the quantity of oxidizer is low compared with the known stoichiometric ratio.

However, there is a need to stabilize burner flames, particularly under lean conditions, in order in particular to limit fuel consumption/reduce greenhouse gas emissions.

Faced with this problem, a person skilled in the art would have been prompted to develop an already-known technical solution known as “bluff-body”, which is disclosed in particular in patent EP1474636B1. According to this concept, the combustion chamber is provided with at least one flame-stabilizing element located proximate to the inner wall of the combustion chamber and the expansion orifice, this flame-stabilizing element constituting a recirculation area wherein at least part of the combustion between oxidizer(s) and fuel(s) can be maintained, in order to stabilize the burner flame there.

Recent in-house observations by the inventors have, however, highlighted the limitations of such a “bluff-body” solution. As a result, certain flame instabilities remain and are linked in particular to the very high velocity of the fluids leaving the stabilizer element, which tends to blow out the flame despite the compensations provided by the recirculation areas located downstream of the stabilizer element. In addition, the stabilizer elements must be formed inside the combustion chamber, which necessarily implies additional technical production constraints. Lastly, these stabilizing elements are subject to high thermal stress, and therefore have limited durability.

Replacing them is further technically complex and costly.

There is therefore an additional need to increase burner durability and flame stability.

The invention meets this need, and relates to a burner for stretching glass fibers, comprising:
a ring-shaped combustion chamber, preferentially delimited by walls made of a refractory material, opening onto a circular expansion slot, the direction of which is substantially parallel to the axis of the burner, and
an injection system comprising at least one injector, preferentially tubular in shape, arranged to supply the combustion chamber with fuel and with oxidizer in the gaseous state,
the burner being characterized in that the injector comprises at least one angular deflection element suitable for generating a stream of oxidizer and/or fuel, the flow of which forms a swirl.

In this text, “tubular” means an injector made up of one or a succession of coaxial hollow cylinders whose central cavity is an injection chamber opening onto the combustion chamber. Angular deflection refers to the injector's modification of the trajectory of the oxidizer and/or fuel flow to make it form a swirl. The fuel can be in liquid or gaseous form. The oxidizer is chosen from an open-ended list, comprising air. A “swirl” flow is a spiral flow with a non-negligible tangential, or azimuthal, component, so that a pressure drop occurs along the injector axis, creating an internal recirculation area. As shown in [FIG. 7], this internal recirculation area allows the flame to catch near the injector outlet. Indeed, such an area is characterized by high levels of negative axial velocity. Flame retention is further enhanced by the presence of toroidal recirculation areas, which return a portion of the burnt gases to the base of the combustion chamber, thus significantly preheating the fresh gases.

As the flame is more stable, it is thus possible to reduce the amount of fuel (gas) injected into the combustion chamber without the risk of flame blowout. A burner according to the invention can therefore significantly improve combustion efficiency, particularly in lean operation, where the ratio of the quantity of fuel (gas) to the quantity of oxidizer (air) is low. With the same heating capacity, fuel consumption and the associated CO2 emissions are therefore reduced. Additionally, the extended operating range of the burner provides greater flexibility in fiber-stretching operating conditions. This allows the diameter and/or length of the glass fibers to be varied.

Finally, since the improved flame retention is due solely to aerodynamic recirculation movements generated proximate to the injector, a burner according to the invention has improved durability over time compared with a “Bluff-body” type burner, and is moreover compatible with the injection of a premix of fuel and oxidizer, unlike a “Bluff-body” type burner.

According to a particular embodiment, said angular deflection element has a swirl number S that satisfies the equation S=2/3 tan φ, with φ the angle of angular deflection of the oxidizer and/or fuel flow after passage through the injector, said swirl number S being between 0.10 and 2.00, preferentially between 0.25 and 1.70, even more preferentially between 0.35 and 1.40, even more preferentially between 0.45 and 1.10, even more preferentially between 0.55 and 0.90, even more preferentially between 0.65 and 0.70.

The intensity of the rotary motion of the flow is characterized by the value of the swirl number S at the injector outlet. The swirl number S is a general expression of the ratio between tangential and axial momentum flows and is defined by the following formula:

$$S = \frac{{\int }_{0}^{∞} {UWr}^{\text{?}} dr}{{R}_{e} {\int }_{0}^{∞} {U}^{\text{?}} rdr} \qquad [ Math . 1 ]$$

$$\text{?} \text{indicates text missing or illegible when filed}$$

where U and Ware respectively the axial and tangential components of the mean flow velocity, and R^{e} is the radius.

In the context of the invention, this swirl number S is approximated by the formula S=2/3 tan φ, with φ the angle of angular deflection of the oxidizer and/or fuel flow after passage through the injector.

Increasing the value of the swirl number S reduces the flame height, but tends to increase the flame opening. Advantageously, adopting a wide flame opening makes it possible to limit the number of injectors arranged around the perimeter of the combustion chamber, while guaranteeing homogeneous heating of the latter.

According to a particular embodiment, said angular deflection element is a ring coaxial to the injector, preferentially removable, comprising at least one lateral duct adapted to allow the introduction of the swirl flow of oxidizer and/or fuel into the injection chamber of the injector with said angular deflection angle ¢, the value of which is preferentially between 10° and 80°, even more preferentially between 20° and 70°, even more preferentially between 30° and 60°, even more preferentially between 40° and 50°.

According to this particular embodiment, the angle formed by the lateral duct with respect to the normal of the circular section of the ring corresponds to the angular deflection angle φ of the oxidizer and/or fuel flow used to calculate the swirl number S.

When this angle φ tends toward values of 0° and 90°, the swirl effect disappears, and the flow velocity tends to be exclusively axial, thus impacting the swirl number S, and therefore the flame structure. In contrast, when the value of this angle φ tends toward 45°, the swirl effect increases to enable optimum mixing of the fuel and oxidizer. With the same amount of combustive fuel, it is possible to reduce the amount of fuel injected.

The removable nature of the angular deflection ring means that it can be replaced more easily and at lower cost, for maintenance purposes, to adapt the injector to a new operating range.

According to an alternative embodiment, said angular deflection element can be a set of deflectors arranged within the injection chamber to set the oxidizer and/or fuel flow in rotation.

According to a particular embodiment, the injection system is adapted to separately supply said injector with fuel on the one hand, and oxidizer on the other.

The risks of flame instability previously disclosed tend to discourage a person skilled in the art from implementing a separate fuel and oxidizer supply on current injectors. In the context of current injectors, mixing fuel and oxidizer only at the injection chamber would only be partial, and would not guarantee satisfactory combustion efficiency and flame stability. However, it has been observed that an injector according to the invention allows, in comparison with traditional injectors, a much faster and more efficient mixing of fuel and oxidizer, owing to the high levels of turbulence. Since the proportion of fuel required for ignition and combustion is reduced, it is possible to further reduce the concentration of fuel (gas), and to inject it separately from the oxidizer (air).

Separate injection of this kind protects against the risk of flashback, in the absence of an oxidizer/fuel mixture upstream of the injector, and makes it possible to preheat the oxidizer (air) before injection, thereby improving combustion efficiency and lowering the flammability (ignition) limit of the mixture. This therefore makes it possible to further reduce fuel consumption, which in turn reduces emissions of combustion gases (carbon dioxide). It should be noted that such preheating is prohibited in the context of premixing fuel and oxidizer, due to the risk of explosion.

According to a particular embodiment, said injector comprises a central duct adapted for injecting a fuel flow along the injector axis, the oxidizer flow being intended to flow through said deflection element.

Central fuel injection ensures optimum mixing of oxidizer (air) and fuel (gas) flows. According to a particular embodiment, such a central duct extends at least partly into the injection chamber of the injector.

According to a particular embodiment, the outer surface of the portion upstream of said central duct is frustoconical in shape, the diameter of said outer surface decreasing on this portion, along the direction of injection.

This frustoconical shape prevents the boundary layer from becoming detached from the swirl flow, thereby reducing the risk of unwanted turbulence.

In a particular embodiment, the injector outlet is positioned within the injection chamber, at a distance of between 0 and 45 mm from the point of entry of the injected flow of oxidizer and fuel into the combustion chamber.

Above this value range, flow losses are too high, due to the intensity of the swirl flow of oxidizer. Conversely, as this distance tends toward 0, or in other words, as the injector outlet approaches the combustion chamber, the central duct is subject to excessive wear due to its close proximity to the inside of the combustion chamber of the burner, and the heat it generates. Thus, preferentially, the distance between the injector outlet and the point of entry of the injected flow of oxidizer and fuel into the combustion chamber is greater than 5 mm, even more preferentially greater than 10 mm, even more preferentially greater than 15 mm, even more preferentially greater than 20 mm.

According to a particular embodiment, the cross-section of the injector outlet is straight in relation to the injector axis.

The inventors have found that the beveled cut of the injector at the gas outlet, as done in the state of the art, tends to oppose the swirl circulation of the oxidizer/fuel mixture and therefore reduces the beneficial technical effects associated therewith. In contrast, cutting the injector tip to have a cross-section that is straight in relation to the burner axis produces a more stable flame that takes full advantage of the benefits of swirl injection.

According to a particular embodiment, the point of entry of the injected flow of oxidizer and fuel into the combustion chamber is positioned proximate to the center of the combustion chamber wall that is most distal from the burner axis.

The most distal wall from the burner axis corresponds to the peripheral wall of the combustion chamber. In view of the usual geometry of an annular combustion chamber, an inlet thus positioned in the combustion chamber for said injected flow of oxidizer and/or fuel is substantially equidistant from the upper and lower walls of the combustion chamber, which makes it possible to obtain a more homogeneous and stable flame, particularly in view of the gas flows circulating in said combustion chamber.

According to a particular embodiment, said point of entry of said injected flow of oxidizer and fuel into the combustion chamber has a cross-sectional diameter adapted based on the desired flame stabilization distance.

The diameter of the outlet section affects the flow ejection velocity. The smaller the cross-section, the greater the ejection velocity, and the greater the flame stabilization distance. The flame is then called “lifted”. Above a certain ejection velocity, the flame is “blown out”. On the contrary, the larger the cross-section, the lower the ejection velocity. Below a certain ejection velocity, there is a risk of the flame stabilizing inside the refractory wall, which should be avoided.

According to a particular embodiment, said injection system comprises a crown for distributing the flow of oxidizer and/or fuel to said at least one injector, said crown being preferentially supplied via a plurality of inlets uniformly distributed around the circumference of said crown, the number of inlets being even more preferentially equal to the number of injectors.

The use of such a distribution crown ensures even distribution of the gas flow in the injectors. Increasing the number of inlets around the circumference of the crown helps promote this even distribution.

The invention also relates to a method for manufacturing glass fibers, characterized in that it uses at least one burner like the one disclosed above.

According to a particular embodiment, the manufacturing method implements at least one burner whose injection system is adapted to separately supply said injector with fuel on the one hand, and with oxidizer on the other hand, said manufacturing method comprising a step of separately supplying the injector with fuel on the one hand, and with oxidizer on the other hand, as well as a prior step of preheating said fuel, preferentially by means of gases resulting at least in part from combustion.

Preheating the fuel improves combustion efficiency and lowers the flammability (ignition) limit of the fuel/oxidizer mixture. Using gases derived at least in part from combustion, and therefore already heated, to do this reduces the overall energy consumption of the melting and fiber-stretching method. Since fuel consumption is reduced in relative terms, such preheating also reduces pollutant emissions.

The invention also relates to a glass fiber obtained by implementing such a manufacturing method.

The invention also relates to a method of controlling a burner like the one disclosed above, said method comprising a step of controlling the flow of oxidizer and/or fuel based on a measured/estimated temperature and/or pressure value, preferentially collected inside the combustion chamber.

A burner according to the invention enables temperature and/or pressure parameters to be varied over wider ranges than known burners.

The invention also relates to a computer program downloadable from a communication network and/or recorded on a recording medium suitable for being read by a computer and/or executed by a processor, comprising an instruction code for implementing such a control method.

This program may use any programming language, and be in the form of source code, object code, or a code somewhere between source code and object code, such as in a partially compiled form.

The invention also covers a computer recording medium, on which such a computer program is recorded. The recording medium may be any entity or device capable of storing the program. For example, the medium may comprise a storage means, such as a read-only memory, a rewritable nonvolatile memory, for example a USB stick, an SD card, an EEPROM, or even a magnetic recording means, for example a hard disk. The recording medium may also be an integrated circuit in which the program is incorporated, the circuit being designed to execute or to be used in the execution of the method. The recording medium may be a transmissible medium such as an electrical or optical signal, which can be carried by an electrical or optical cable, by radio or by other means. The program according to the invention may in particular be downloaded over an Internet type network.

The invention also relates to a fiber-stretching installation equipped with one or more burners like the one disclosed above.

Further features and advantages of the invention will become apparent from the following description of particular embodiments, given merely as illustrative and non-limiting examples, and the appended figures, for which:

FIG. 1 is a schematic cross-section of a burner known from the state of the art,

FIGS. 2, 3 and 4 are schematic depictions of the ejection velocity of the fuel/oxidizer mixture flow (uf) in a duct on the one hand, and the flame displacement velocity (Sf) on the other,

FIG. 5 is a schematic cross-section of a burner according to the invention,

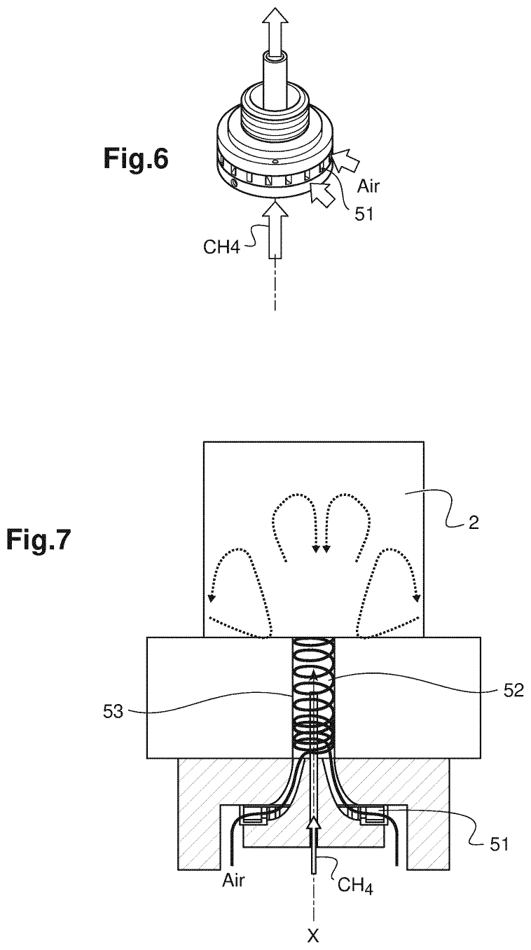

FIG. 6 is a perspective view of an injector according to the invention,

FIG. 7 is a schematic cross-section of an injector according to the invention, wherein the oxidizer/fuel flows are shown as thin interrupted lines,

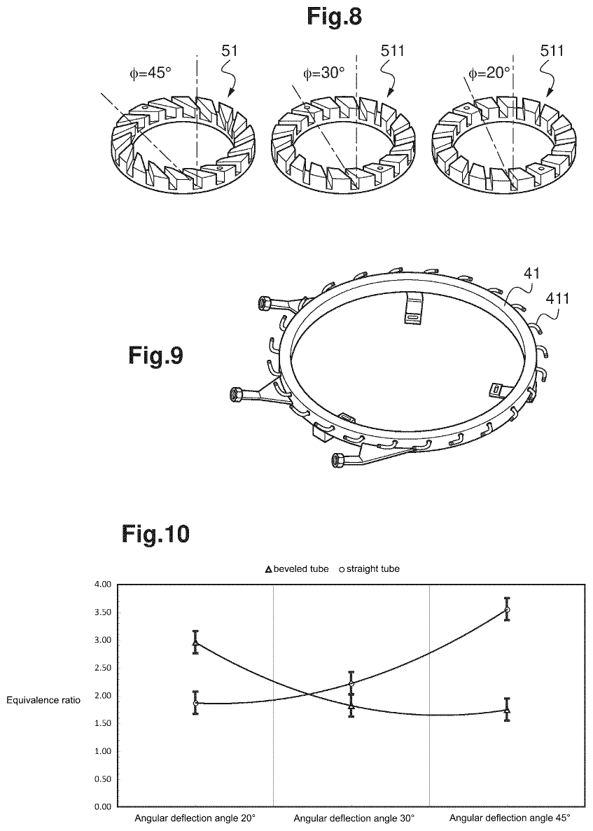

FIG. 8 is a perspective view of three injection rings with angular deflection angles of 45°, 30° and 20°, respectively,

FIG. 9 is a perspective view of a combustion/fuel flow distribution crown,

FIG. 10 is a pictorial of the value of the equivalence ratio of fuel to oxidizer, based on variations in the angular deflection angle and the geometry of the injector outlet cross-section,

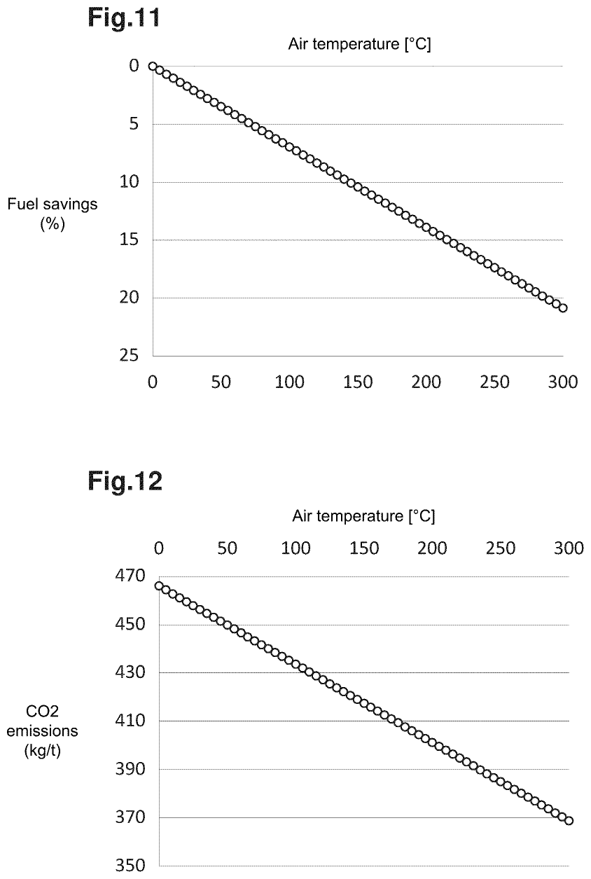

FIG. 11 is a pictorial of an estimate of the value of fuel gain based on the preheating temperature of the oxidizer,

FIG. 12 is a pictorial of the estimated reduction in pollutant gas emissions based on the preheating temperature of the oxidizer,

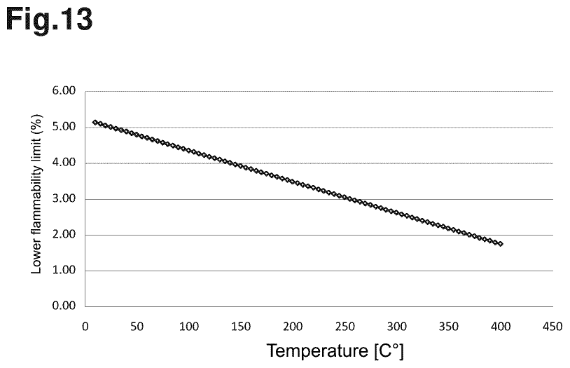

FIG. 13 is a pictorial of the variation of the lower flammability limit of the fuel based on the preheating temperature of the oxidizer,

The various elements illustrated in the figures are not necessarily shown to actual scale, the emphasis being more on representing the general operation of the invention. In the various figures, unless otherwise indicated, reference numbers that are identical represent similar or identical elements.

Several particular embodiments of the invention are presented below. It is understood that the present invention is in no way limited by these particular embodiments, and that other embodiments are perfectly possible.

According to a particular embodiment, and as shown by FIG. 5, a burner 1 according to the invention comprises:
a ring-shaped combustion chamber 2, preferentially delimited by walls made of a refractory material, opening onto a circular expansion slot 3, the direction of which is substantially parallel to the axis of the burner 1; and
an injection system 4 comprising at least one injector 5 preferentially tubular in shape, arranged to supply the combustion 2 fuel and with oxidizer in the gaseous state,

In particular, such a burner 1 according to the invention comprises an injector 5 provided with at least one angular deflection element 51 adapted to generate a flow of oxidizer and/or fuel, the flow of which forms a swirl.

According to a particular embodiment, and as shown in greater detail by FIGS. 6 and 7, said angular deflection element 51 is a ring coaxial with the injector 5, comprising at least one lateral duct 511 adapted to allow the introduction of the swirl flow of oxidizer into the injection chamber 52 of the injector 5 with an angular deflection angle, formed by the lateral duct with respect to the normal of the circular cross section of the ring.

According to this particular embodiment, this angular deflection angle φ is 45°. The corresponding swirl number S is 0.67, which optimizes the mixing of fuel and oxidizer, reducing the amount of fuel to be injected for the same amount of oxidizer.

According to alternative embodiments, this angle can take on other values. By way of illustration and non-limitingly, [FIG. 8] is a perspective view of three injection rings with angular deflection angles of 45°, 30° and 20°, respectively.

According to other embodiments of the invention which are not shown, said angular deflection element can be a set of deflectors arranged within the injection chamber to set the oxidizer and/or fuel flow in rotation.

According to the particular embodiment shown in FIGS. 6 and 7, said injector 5 comprises a central duct 53 which extends partially into the injection chamber 52 of the injector and is adapted for injecting a fuel flow along the axis X of the injector 5, the oxidizer flow being intended to flow through said deflection element 51.

According to an embodiment shown in [FIG. 5], the injection system 4 of the burner 1 on the one hand comprises a supply of fuel gas injected via the central duct 53, for example in the form of methane. On the other hand, it comprises a separate supply 42 of oxidizer, for example in the form of air, which is introduced into the injector via the lateral ducts 511 of the injection ring 51, according to a swirl flow, that is, a flow animated by a spiral movement whose tangential component, also known as azimuthal component, is not negligible. The entire mixture is produced in the injection chamber 52, before being ejected into the combustion chamber 2 of the burner 1. By way of illustration, oxidizer/fuel flows are shown as thin broken lines in [FIG. 7].

Such a separate supply of fuel on the one hand, and of oxidizer on the other hand, protects against the risk of flashback, in the absence of an oxidizer/fuel mixture upstream of the injector, and makes it possible to preheat the oxidizer (air) before injection, thereby improving combustion efficiency, reducing pollutants, and lowering the flammability (ignition) limit of the mixture, as disclosed below in relation to FIGS. 11, 12 and 13.

In a particular embodiment, the air is preheated at least in part by recovering heat from the combustion gases produced by the burner, the glass melting furnace (e.g. via heat exchangers) and/or any other heat source generated during the glass wool manufacturing method.

Note that the invention is not limited to a particular choice of fuel and/or oxidizer. Thus, the fuel can be in liquid or gaseous form, and the oxidizer is chosen from an open-ended list including oxygen and air.

As shown in [FIG. 5], said injection system 4 comprises a crown 41 for distributing the flow of oxidizer and/or fuel to said at least one injector 5. This crown 41 is shown in more detail in [FIG. 9], and is advantageously supplied via a plurality of inlets 411 evenly distributed around the circumference of said crown 41, to enable homogeneous distribution of the fuel flow in the injectors.

According to an alternative embodiment of the invention, not shown, the injector does not comprise a central duct, or the latter is closed. The fuel/oxidizer mixture is then introduced upstream of the injector, via the injection ring only.

Once the fuel/oxidizer have been mixed, this mixture is ejected into the combustion chamber 2 of the burner 1, via a cross-sectional outlet. Given the swirl nature of the flow injected into combustion chamber 2, a reduction in pressure occurs along the injector axis, creating an internal recirculation area. As shown in [FIG. 7], this internal recirculation area allows the flame to catch near the injector outlet. Indeed, such an area is characterized by high levels of negative axial velocity. Flame retention is further enhanced by the presence of toroidal recirculation areas, which return a portion of the burnt gases to the base of the combustion chamber, thus significantly preheating the fresh gases. As the flame is more stable, it is thus possible to reduce the amount of fuel (gas) injected into the combustion chamber without the risk of flame blowout, as disclosed below in relation to [FIG. 10].

As shown in [FIG. 5], the point of entry 21 of the injected flow of oxidizer and fuel into the combustion chamber 2 is positioned proximate to the center of the combustion chamber 2 wall that is most distal from the burner axis, that is, the peripheral wall of the combustion chamber 2. This results in a more homogeneous and stable flame, particularly in view of the gas flows circulating in the combustion chamber. The point of entry 21 also has a cross-sectional diameter of (15 mm, for a fuel and oxidizer flow rate of approx. 1200 nm³/h.), to help stabilize the flame at the inlet of the chamber 2.

During combustion, sensors inside the chamber 2 collect pressure and temperature measurements to facilitate control of the burner 1, in particular by varying the injection rate of the oxidizer and/or fuel flow.

Conventionally, the fumes resulting from the combustion of the fuel/oxidizer mixture are ejected via the expansion slot 3 of the annular burner in a direction substantially parallel to the axis of burner 1, in order to stretch and/or thin the glass fibers ejected from the fiber-stretching spinner.

In one embodiment, part of these fumes is used to preheat the oxidizer (air) before it is introduced into the burner injector 1.

$$\frac{( Q {v}_{Fuel} \times Fuel density ) / ( {Qv}_{Oxidizer} \times Oxidizer density )}{( m\_Fuel / m\_Oxdizer ) theoretical} \qquad [ Math . 2 ]$$

With Qv: volume flow rate
m_: mass flow rate
(m_Fuel/m_Oxidizer) theoretical=0.1

Tests are carried out in a combustion laboratory, on a test bench reproducing flame combustion conditions in a ring burner, at atmospheric pressure and ambient temperature. The aim of the tests is to determine the injector's stability limit. This is achieved by setting the gas (fuel) flow rate and gradually increasing the air (oxidizer) flow rate until an unstable flame is obtained. The ratio of fuel flow to oxidizer flow is then measured.

In order to assess the impact of the geometry of the injector outlet cross section, a first series of tests is carried out with an injector according to the invention, with a straight outlet cross section, as shown in FIGS. 5 to 7, and a second series of tests is carried out with an injector according to the invention, but whose outlet cross section is beveled, at an angle of 15° with respect to the x-axis of the injector. For each of these series, the injectors are tested with three formats of injection rings with angular deflection angles of 20°, 30° and 45°, respectively.

These tests show that for an injector with a straight cross section, the fuel-to-oxidizer ratio is close to 3.00 at an angle of 20°, and decreases as the deflection angle varies between 20° and 45°, reaching a minimum of 1.3 at 45°. The flame is the most stable at this value, which makes it possible to reduce the quantity of fuel (gas) injected into the combustion chamber without the risk of flame blowout or flashback. A burner according to the invention can therefore significantly improve combustion efficiency, particularly in lean operation, where the ratio of the quantity of fuel (gas) to the quantity of oxidizer (air) is low. With the same heating capacity, fuel consumption and the associated CO2 emissions are therefore reduced.

In the case of injectors with beveled outlet cross sections, at an angle of 20° the fuel-to-oxidizer ratio is close to 1.80, and increases as the deflection angle varies between 20° and 45°, reaching a value of 3.50 at 45°.

It has been observed that for an angle value of 20°, the performance of the beveled injector is better than that of the injector with a straight profile section. This is because, for this 20° angle value, the swirl effect of the flow, and therefore the mixing of oxidizer and fuel, is low, which limits the performance of the straight cross section injector. The beveled profile generates a velocity gradient at its end, which seems to favor the mixing of oxidizer and fuel, resulting in better performance at low angle values.

However, this beveled profile has the negative effect of opposing the swirl effect induced by the injector, which has a negative impact on the performance of the beveled injector when this swirl effect becomes more powerful.

As a result, for angle values of 30° and 40°, an injector with a straight profile cross section offers better performance than a beveled injector. In particular, the performance of the beveled injector deteriorates significantly at 45°.

The first experimental protocol therefore identifies the straight outlet cross section injector with a 45° deflection angle as offering the best performance in terms of flame stabilization.

According to a second experimental protocol, the results of which are shown in [FIG. 11], the value of the fuel gain (natural gas) is estimated based on the preheating temperature of the oxidizer (air).

According to this protocol, the burner is considered as a black box whereupon a power balance is performed by applying the first principle of thermodynamics (conservation of energy). In other words, combustion is studied holistically, from the reactants to the products, without taking into account the reaction mechanism.

In accordance with the first principle of thermodynamics, the total energy stored by the control volume is the sum of the power received thermally, mechanically and from the energy supplied by the molecules.

In the context of the invention, the following assumptions are taken into account:
Energy does not accumulate in the combustion chamber
There are no moving mechanical parts to do the work,
Kinetic and potential energies are neglected in comparison with the internal energy of the gases.

Heat loss through the walls is estimated at 10% of the energy released during the reaction, or 10% of the gross calorific value (GCV)

$${h}_{s}^{m} = {h}_{e}^{m} - 0.1 GCV \qquad [ Math . 3 ]$$

Where hₛ^{m} and hₑ^{m} are the output and input molar enthalpies, respectively.

The enthalpies are a function of temperature only. Knowing the output enthalpy of the burnt gases, it is possible to deduce the temperature of these gases.

The enthalpy of the products is calculated from this equation to determine the temperature at which the products of the reaction have the same enthalpy.

Once a final temperature has been set, the gain in combustion compared to preheating the reactants is then determined.

The results obtained show a reduction in the fuel-to-oxidizer ratio, and therefore an improvement in the burner's energy efficiency, as the preheating temperature rises.

According to a third experimental protocol, the results of which are shown in [FIG. 12], the reduction in pollutant gas emissions (carbon dioxide) is estimated based on the preheating temperature of the oxidizer (air).

From the equation for the chemical reaction of methane combustion with air, in the perfect combustion configuration we can write: CH₄₊₂O₂→2 H₂O+CO₂.

This means that for every cubic meter of methane burned, 1 m³ of carbon dioxide is released.

The results obtained show a reduction in pollutant gas emissions (carbon dioxide) as the preheating temperature rises.

[FIG. 13] is a pictorial of the variation of the lower flammability limit of the fuel (natural gas) based on the preheating temperature of the oxidizer (air).

For the flame to spread, the layer of gas next to the one being burned must be brought to a certain temperature so that it can catch fire quickly. If the gas is heated to a high temperature, the amount of heat to be supplied by the burning layer is less. The lower flammability limit is reduced. Experience shows that there is a linear relationship between flammability limit and initial temperature. The following empirical formula, used by INRS (Institut National de Recherche et de Sécurité), establishes a safety value for the lower flammability limit L at temperature t, as a function of the limit L0 at the reference temperature T0:

$$L = {L}_{0} [ 1 - \frac{t - {t}_{0}}{600 - {t}_{0}} ] \qquad [ Math . 4 ]$$

The results show that the lower flammability limit decreases as the preheating temperature increases.

The values disclosed in this text are not to be understood as strictly limited to the numerical values quoted. Instead, unless otherwise specified, each value designates both the value exactly quoted and a range of functionally equivalent values encompassing that value.

Although particular embodiments of the present invention have been illustrated and described, it is obvious that various other changes and modifications may be made within the spirit and scope of the invention. The present text is therefore intended to cover, in the scope of protection defined by the appended claims, all modifications that fall within the scope of the present invention.

1. A burner suitable for stretching glass fibers, the burner comprising:
a ring-shaped combustion chamber opening onto a circular expansion slot, a direction of which is substantially parallel to an axis of the burner; and
an injection system comprising at least one injector arranged to supply the combustion chamber with fuel and with oxidizer in the gaseous state,
wherein the injector comprises at least one angular deflection element configured to generate a stream of oxidizer and/or fuel, a flow of which forms a swirl.

2. The burner according to claim 1, wherein said angular deflection element has a swirl number S which satisfies the equation S=2/3 tan Φ, with Φ the angle of angular deflection of the oxidizer and/or fuel flow after passage through the injector, said swirl number S being between 0.10 and 2.00.

3. The burner according to claim 2, wherein said angular deflection element is a ring coaxial to the injector comprising at least one lateral duct adapted to allow introduction of the swirl flow of oxidizer and/or fuel into the injection chamber of the injector with said angular deflection angle Φ.

4. The burner according to claim 1, wherein the injection system is adapted to separately supply said injector with fuel on the one hand, and oxidizer on the other.

5. The burner according to claim 4, wherein said injector comprises a central duct adapted to inject a fuel flow along the axis of the injector, the oxidizer flow being intended to flow through said deflection element.

6. The burner according to claim 5, wherein an outer surface of the portion upstream of said central duct is frustoconical in shape, a diameter of said outer surface decreasing on said portion, along a direction of injection.

7. The burner according to claim 5, wherein an outlet of the injector is positioned within the injection chamber, at a distance of between 0 and 45 mm from a point of entry of the injected flow of oxidizer and fuel into the combustion chamber.

8. The burner according to claim 1, wherein said injector has an outlet cross section which is straight in relation to an axis of the injector.

9. The burner according to claim 1, wherein a point of entry of the injected flow of oxidizer and fuel into the combustion chamber is positioned proximate to a center of the combustion chamber wall that is most distal from the burner axis.

10. The burner according to claim 9, wherein said point of entry of said injected flow of oxidizer and fuel into the combustion chamber has a cross-sectional diameter adapted based on the desired flame stabilization distance.

11. The burner according to claim 1, wherein said injection system comprises a crown for distributing the flow of oxidizer and/or fuel to said at least one injector.

12. A method for manufacturing glass fibers, comprising utilizing at least one burner according to claim 1.

13. A method for manufacturing glass fibers, comprising utilizing at least one burner according to claim 4 and separately supplying the injector with fuel on the one hand, and with oxidizer on the other hand, said manufacturing method comprising a prior step of preheating said fuel.

14. A glass fiber obtained by implementing a manufacturing method according to claim 12.

15. A method of controlling a burner according to claim 1, said method comprising controlling the flow of oxidizer and/or fuel based on a measured/estimated temperature and/or pressure value.

16. A non-transitory recording medium suitable for being read by a computer, comprising an instruction code for implementing a control method according to claim 12.

17. A fiber-stretching installation equipped with one or more burners according to claim 1.

18. The burner according to claim 1, wherein the ring-shaped combustion chamber is delimited by walls made of a refractory material.

19. The burner according to claim 1, wherein the injector has a tubular shape.

20. The burner according to claim 1, wherein said swirl number S being between 0.25 and 1.70.
